(19) United States
(12) Patent Application Publication
(10) Pub. No.: US 2017/0311736 A1
(43) Pub. Date: Nov. 2, 2017

(54) ARTICLE DISPLAY STAND

(71) Applicant: SZ DJI TECHNOLOGY CO., LTD., Shenzhen (CN)

(72) Inventors: Haibin ZHENG, SHENZHEN (CN); Min KIM, SHENZHEN (CN)

(21) Appl. No.: 15/650,617

(22) Filed: Jul. 14, 2017

Related U.S. Application Data
(63) Continuation of application No. PCT/CN2015/070812, filed on Jan. 15, 2015.

(51) Int. Cl. A47F 5/16; A47F 7/00; A47F 5/00; G09F 5/00

(52) U.S. Cl. CPC A47F 5/16; A47F 7/00; A47F 5/00; G09F 5/00

(57) ABSTRACT

An article display stand includes a first supporting part configured to support an aerial vehicle body of an aerial vehicle and a second supporting part configured to support a control terminal of the aerial vehicle.

### CROSS-REFERENCE TO RELATED APPLICATION

This is a continuation application of International Application No. PCT/CN2015/070812, filed on Jan. 15, 2015, the entire contents of which are incorporated herein by reference.

### TECHNICAL FIELD

The present disclosure relates to the field of article display, and more particularly, to an article display stand for displaying an unmanned aerial vehicle.

### BACKGROUND

The existing article display stand generally includes a single placement surface for placing an article to be displayed, and when the article to be displayed includes a plurality of separable parts, the plurality of separable parts are all placed on the placement surface, which easily leads to disorder of the article to be displayed and affects a display effect.

### SUMMARY

In view of this, the present disclosure provides an article display stand having a better display effect.

An article display stand for displaying an aerial vehicle including an aerial vehicle body and a control terminal includes a first supporting part for supporting the aerial vehicle body and a second supporting part for supporting the control terminal.

Further, the first supporting part includes a first placement portion which supports the aerial vehicle body at a first display height.

Further, the second supporting part includes a second placement portion which supports the control terminal at a second display height.

Further, the control terminal includes a mobile terminal for controlling an action of at least one of a shooting apparatus, a flight apparatus, and a stabilizing device on the aerial vehicle body.

Further, the control terminal includes a mobile terminal for displaying and/or detecting a state and related information of at least one of a shooting apparatus, a flight apparatus, and a stabilizing device on the aerial vehicle body.

Further, the second placement portion includes a first positioning structure for supporting the mobile terminal at the second display height.

Further, the second placement portion further includes a second positioning structure which is higher than the first positioning structure.

Further, the mobile terminal is supported by the second positioning structure.

Further, the control terminal includes a remote controller for controlling an action of at least one of a shooting apparatus, a flight apparatus, and a stabilizing device on the aerial vehicle body.

Further, the second placement portion further includes a second positioning structure which is higher than the first positioning structure.

Further, the remote controller is supported by the second positioning structure.

Further, the control terminal includes a mobile terminal and a controller. The mobile terminal is used for displaying and/or detecting a state of at least one of a shooting apparatus, a flight apparatus, and a stabilizing device on the aerial vehicle body. The remote controller is used for controlling an action of at least one of the shooting apparatus, the flight apparatus, and the stabilizing device on the aerial vehicle body.

Further, the second supporting part includes a first positioning structure and a second positioning structure. The first positioning structure supports one of the mobile terminal and the remote controller, and the second positioning structure supports the other one of the mobile terminal and the remote controller.

Further, the display stand further includes an information display portion which is located on the second supporting part.

Further, the information display portion includes a bracket and a display supported by the bracket.

Further, the control terminal is further used for controlling the display.

Further, the information display portion includes a wireless communication unit connected with the display, and the display is capable of exchanging information with an external apparatus through the wireless communication unit.

Further, the display stand further includes a light-emitting portion which is a light source required by the display stand.

Further, the light-emitting portion is a light band located between the first supporting part and the second supporting part.

Further, the light-emitting portion is at least one light source which is located near parts where the aerial vehicle body and the control terminal are supported.

Further, the first supporting part includes a first leg at the bottom, a first supporting plate at the top, and a first connecting portion that connects the first leg with the first supporting plate, and the first placement portion is a surface of the first supporting plate.

Further, the first leg is in a shape of any one of the following symbols: square C, C, Σ and Π.

Further, the second supporting part includes a second leg at the bottom, a second supporting plate, and a second connecting portion that connects the second leg with the second supporting plate, and the second placement portion is a surface of the second supporting plate.

Further, the second placement portion is inclined at a predetermined angle relative to a bottom face of the second leg.

Further, the display is supported at a height between 150 cm and 190 cm.

Further, the first positioning structure includes a positioning portion and a stop protruding portion. The positioning portion is used for mating with the mobile terminal to dispose the mobile terminal on the second placement portion. The stop protruding portion is used for preventing the mobile terminal from tipping over and/or preventing the mobile terminal from sliding along the second placement portion. Alternatively, the first positioning structure of the article display stand is a frame structure, and the first positioning structure encloses the mobile terminal therein.

Further, the second positioning structure includes a mounting block and a plurality of hooks. The mounting block is fixedly arranged on the second placement portion, and the hooks are fixedly arranged on the mounting block for holding the remote controller.

Another article display stand for displaying an article to be displayed which consists of a plurality of separable parts includes a first supporting part including a first placement portion which is used for supporting at least one of the separable parts at a first display height, and a second supporting part including a second placement portion which is used for supporting at least another one of the separable parts at a second display height.

Further, the first display height is different from the second display height.

Relative to the conventional technologies, the article display stand according to the present disclosure uses different placement surfaces to set different parts of the article to be displayed, which can thus avoid disorder of the different parts of the displayed article, achieves a better display effect, and can bring about better viewing and operating experience to visitors.

### BRIEF DESCRIPTION OF THE DRAWINGS

FIG. 1 is a three-dimensional view of an article display stand according to an implementation mode of the present disclosure.

FIG. 2 is a left view of the article display stand in FIG. 1.

FIG. 3 is a three-dimensional view of an article display stand according to another implementation mode of the present disclosure.

### DESCRIPTION OF MAIN REFERENCE NUMERALS

TABLE 1

| | |
|---|---|
| Article display stand | 100, 200 |
| First supporting part | 10 |
| First leg | 11 |
| First supporting plate | 12 |
| First placement portion | 121 |
| First connecting portion | 13 |
| Second supporting part | 20 |
| Second leg | 21 |
| Second supporting plate | 22 |
| Second placement portion | 221 |
| First positioning structure | 222, 222′ |
| Positioning hole | 2221 |
| Stop protruding portion | 2222 |
| Second positioning structure | 223 |
| Mounting block | 2231 |
| Hook | 2232 |
| Second connecting portion | 23 |
| Information display portion | 24 |
| Bracket | 241 |
| Display | 242 |
| Mounting frame | 243 |
| Wireless communication unit | 244 |

The present disclosure is further described below in the DETAILED DESCRIPTION OF THE EMBODIMENTS in combination with the aforementioned accompanying drawings.

### DETAILED DESCRIPTION OF THE EMBODIMENTS

The article display stand according to the present disclosure is used for placing an article to be displayed, especially suitable for but not limited to, placing a set of articles consisting of a plurality of separable parts, enabling each separable part in the set of articles to obtain better viewing and operating experience. For example, the article display stand according to the present disclosure can be used for placing and displaying an aerial vehicle body, a shooting apparatus, a mobile terminal and/or a remote controller of an aerial vehicle at the same time, causing the aerial vehicle body, the shooting apparatus, the mobile terminal and/or the remote controller to have most comfortable viewing and operating heights and/or angles respectively.

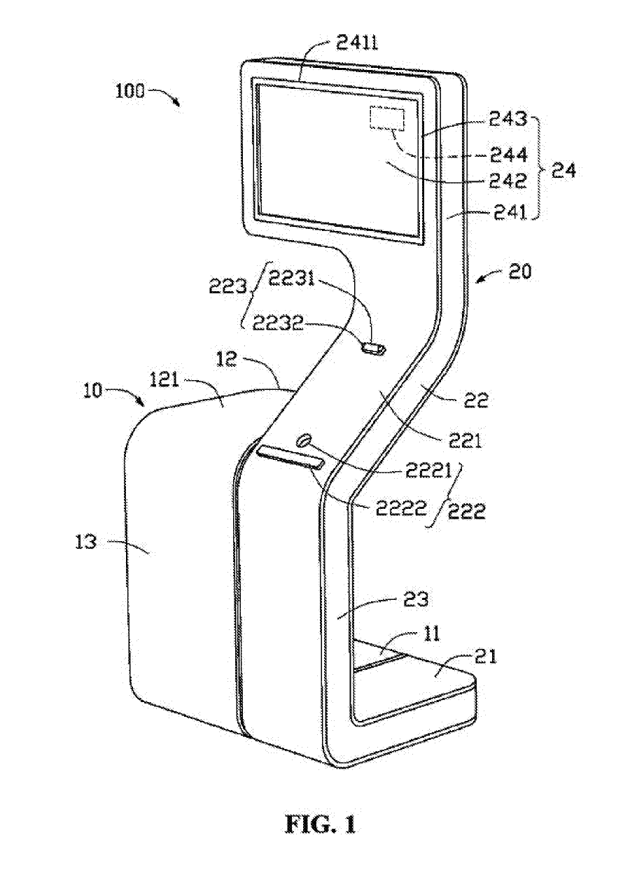

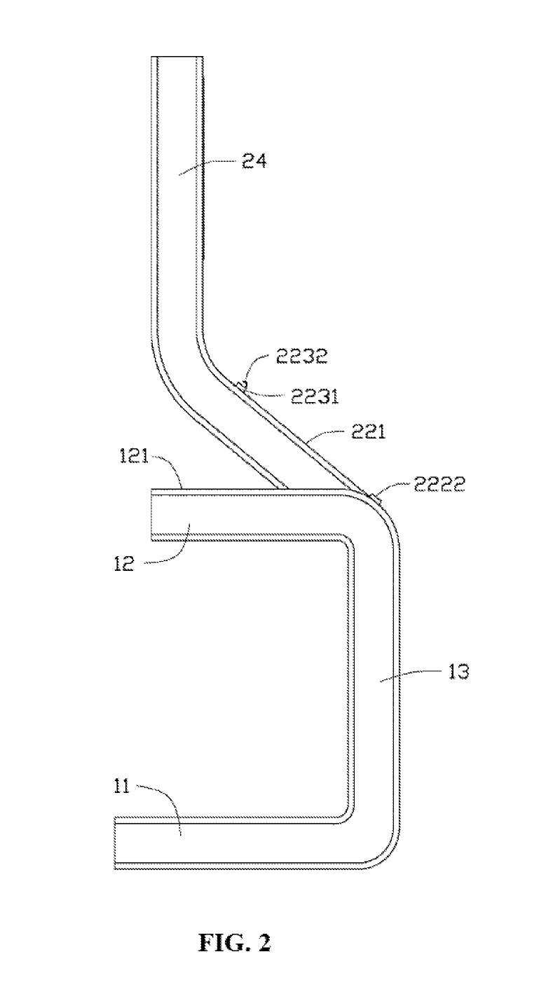

Referring to FIG. 1 and FIG. 2, an article display stand 100 according to an implementation mode of the present disclosure includes a first supporting part 10 and a second supporting part 20. The first supporting part 10 and the second supporting part 20 are arranged side by side. In this implementation mode, the first supporting part 10 and the second supporting part 20 are in a fixed connection. In other implementation modes, the first supporting part 10 and the second supporting part 20 may be connected with each other in a removable manner, or the first supporting part 10 may not be mechanically connected with the second supporting part 20.

It can be understood that other suitable changes may be made to a relative positional relationship between the first supporting part 10 and the second supporting part 20 according to an actual display requirement or viewing and operating requirements. For example, the first supporting part 10 and the second supporting part 20 are disposed left and right at an interval of a predetermined distance, staggered front and back at a predetermined distance or the like. The first supporting part 10 supports the aerial vehicle body at a first display height.

The first supporting part 10 is approximately “square C”-shaped , including a first leg 11 at the bottom, a first supporting plate 12 at the top, and a first connecting portion 13 that connects the first leg 11 with the first supporting plate 12. The first leg 11 is approximately parallel to the first supporting plate 12, and the first connecting portion 13 is disposed between the first leg 11 and the first supporting plate 12 in a manner of being approximately perpendicular to the first leg 11 and the first supporting plate 12. The first leg 11 is a supporting leg when the first supporting part 10 is disposed on a surface such as the ground, a table top, or a platform surface. In other words, the first leg 11 is used for stably placing the first supporting part 10. The first supporting plate 12 has a first placement portion 121 which is used for placing at least one part of the article to be displayed. In this implementation mode, the first placement portion 121 is used for placing the aerial vehicle body and the shooting apparatus of the aerial vehicle. In this implementation mode, the first placement portion 121 is a plane. In some other implementation modes, the first placement portion 121 may be a surface, a slot, a protrusion, or another structure, and the first placement portion 121 may be provided with a positioning structure (not shown) that positions and/or fixes the article to be displayed.

It can be understood that the first supporting part 10 may also be in another bending shape, for example, in a shape of any one of the following symbols: I, C, Σ and Π. The first supporting part 10 employs a bent plate-like structure, which can reduce the overall weight of the article display stand 100 and is easy to carry and transport.

In this implementation mode, the overall height of the first supporting part 10 is between 90 cm and 105 cm, which can support the aerial vehicle body within a first display height range between 100 cm and 115 cm. The first display height is a height suitable for viewing and operating the aerial vehicle body on the first supporting part 10.

The second supporting part 20 is approximately “2”-shaped, including a second leg 21 at the bottom, a second supporting plate 22, a second connecting portion 23 that connects the second leg 21 with the second supporting plate 22, and an information display portion 24. The second leg 21 is approximately perpendicular to the second connecting portion 23, and the second supporting plate 22 is inclined at a predetermined angle relative to the second connecting portion 23. In this implementation mode, an inclination angle of the second supporting plate 22 relative to the second connecting portion 23 is between 30 degrees and 60 degrees. The information display portion 24 is connected to one end of the second supporting plate 22 away from the second connecting portion 23, and the information display portion 24 is approximately perpendicular to the second connecting portion 23.

The second leg 21 is used for stably placing the second supporting part 20. In this implementation mode, the shape and length of the second leg 21 are approximately the same as those of the first leg 11 respectively, and the shape and height of the second connecting portion 23 are approximately the same as those of the first connecting portion 13 respectively, so that the first leg 11 and the second leg 21 as well as the first connecting portion 13 and the second connecting portion 23 can be aligned with each other when the first supporting part 10 and the second supporting part 20 are arranged side by side.

The second supporting plate 22 includes a second placement portion 221 which is inclined at a predetermined angle relative to a bottom face of the second leg 21. In other words, when the second supporting part 20 is disposed on a plane, the second placement portion 221 is inclined the predetermined angle relative to the plane. The second placement portion 221 is provided thereon with a first positioning structure 222 and a second positioning structure 223. The first positioning structure 222 is disposed close to the second connecting portion 23, and the second positioning structure 223 is disposed close to the information display portion 24.

The first positioning structure 222 and the second positioning structure 223 are used for placing separable parts of the article to be displayed. In this implementation mode, the first positioning structure 222 is used for placing the mobile terminal of the unmanned aerial vehicle and supporting the mobile terminal at a second display height, wherein the second display height is a height suitable for viewing and operating the mobile terminal on the second supporting part 20. The second positioning structure 223 is used for placing the remote controller of the aerial vehicle and supporting the remote controller on a third display height, wherein the third display height is a height suitable for viewing and operating the remote controller on the second supporting part 20. It can be understood that the second supporting part 20 may also support the mobile terminal at the third display height while supporting the remote controller at the second display height.

The setting height of the second positioning structure 223 on the second supporting part 20 is greater than that of the first positioning structure 222 on the second supporting part 20. In this implementation mode, the setting height of the first positioning structure 222 on the second supporting part 20 is between 90 cm and 105 cm. The setting height of the second positioning structure 223 on the second supporting part 20 is between 100 cm and 115 cm. Correspondingly, the second positioning structure 223 may support the mobile terminal within a display height range between 100 cm and 115 cm. In some embodiments, the second positioning structure 223 supports the mobile terminal at a display height the same as that of the aerial vehicle body, which can thus ensure that the aerial vehicle body and the remote controller are operated at the same viewing angle.

The first positioning structure 222 includes a positioning portion 2221 and a stop protruding portion 2222. The positioning portion 2221 is used for mating with the mobile terminal to dispose the mobile terminal on the second placement portion 221. In this implementation mode, the positioning portion 2221 is a round hole, and is thus also referred to as a positioning hole. It can be understood that the positioning portion 2221 may be a screw hole internally provided with threads, or the positioning portion 2221 may also be a square hole, an oval hole, a triangular hole or the like or may be another structure such as a hook or a protrusion. The stop protruding portion 2222 is used for preventing the mobile terminal from tipping over and/or preventing the mobile terminal from sliding along the second placement portion 221. In this implementation mode, the stop protruding portion 2222 is a strip-like protruding block.

The mobile terminal may be a tablet computer, a notebook computer, a smartphone or the like.

In some implementation modes, the mobile terminal may control an action of at least one of a shooting apparatus, a flight apparatus, and a stabilizing device of the aerial vehicle. Specifically, the mobile terminal may control activities, shooting and the like of the shooting apparatus such as a camera or a video camera on the aerial vehicle body through an application therein or a function button on the mobile terminal. Alternatively, the mobile terminal may control activities of the stabilizing device on the aerial vehicle body such as a gimbal, or control a rotational speed of the flight apparatus of the aerial vehicle body such as each motor. Thus, the shooting apparatus and the stabilizing device on the aerial vehicle body and the aerial vehicle body are controlled to present different attitudes on the article display stand.

In addition, the mobile terminal may be further used for displaying and/or detecting a state and related information of at least one of a shooting apparatus, a flight apparatus, and a stabilizing device on the aerial vehicle body. A display screen of the mobile terminal may display pictures or video taken or recorded by a shooting device of the aerial vehicle body, and may display the state of the shooting device, for example, a shooting mode and the like. The display screen of the mobile terminal may also display a rotational angle, a rotational speed, and other parameters of the stabilizing device on the aerial vehicle body, and may also display a rotational speed and other parameters of a motor of the aerial vehicle body.

The second positioning structure 223 includes a mounting block 2231 and two hooks 2232. The mounting block 2231 is fixedly arranged on the second placement portion 221, and the hooks 2232 are fixedly arranged on the mounting block 2231. In this implementation mode, the hooks 2232 are at an interval of a predetermined distance along a horizontal direction. The hooks 2232 are used for holding the remote controller. The remote controller is used for controlling flight of the aerial vehicle.

The remote controller may be an infrared remote controller, a radio frequency remote controller or other suitable types of remote controllers. The remote controller may control an action of at least one of a shooting apparatus, a flight apparatus, and a stabilizing device of the aerial vehicle. Specifically, the remote controller may control activities, shooting and the like of the shooting apparatus such as a camera or a video camera on the aerial vehicle body. Alternatively, the remote controller may control activities of the stabilizing device on the aerial vehicle body such as a gimbal, or control a rotational speed of the flight apparatus of the aerial vehicle body such as each motor. Thus, the shooting apparatus and the stabilizing device on the aerial vehicle body and the aerial vehicle body are controlled to present different attitudes on the article display stand.

It can be understood that the control terminal of the aerial vehicle may only include a mobile terminal or a remote controller, and may also include both a mobile terminal and a remote controller. When the control terminal includes both a mobile terminal and a remote controller, the mobile terminal is used for displaying and/or detecting a state of at least one of a shooting apparatus, a flight apparatus, and a stabilizing device on the aerial vehicle body, and the remote controller is used for controlling an action of at least one of the shooting apparatus, the flight apparatus, and the stabilizing device on the aerial vehicle body.

It can be understood that, in other implementation modes, the mounting block 2231 may be omitted in the second positioning structure 223, while the hooks 2232 are disposed on the second placement portion 221 directly, and the number of the hooks 2232 may be appropriately changed according to specific demands.

It can be understood that, in other implementation modes, the mobile terminal and the remote controller may be integrated into one control terminal. In this case, the control terminal may be supported by the first positioning structure or the second positioning structure, or the first positioning structure and the second positioning structure may be integrated into one positioning structure that supports the control terminal.

Further, the article display stand 100 may further include a light-emitting portion (not shown) for providing a light source for the article display stand 100. The light source may be a light band or a point light source. In this implementation mode, the light-emitting portion is a light band located between the first supporting part 10 and the second supporting part 20. In some other implementation modes, the light-emitting portion may also be one or more point light sources located near parts where the aerial vehicle body and the control terminal are supported.

The information display portion 24 is used for displaying product information, description and/or an advertising lamp of the article to be displayed. The information display portion 24 includes a bracket 241, a display 242, a mounting frame 243, and a wireless communication unit 244. The bracket 241 is provided with a mounting slot 2411, the display 242 is disposed in the mounting slot 2411, and the mounting frame 243 is disposed on a peripheral edge of the display 242 and is connected with the bracket 241. The mounting frame 243 is made of an elastic material, and can prevent the display 242 from being damaged due to vibration. In this implementation mode. The mounting frame 243 is made of a rubber material. A surface of the display 242 may be recessed a predetermined size relative to a surface of the bracket 241, and may also be kept flush with the surface of the bracket 241 to maintain a flat structure.

In this implementation mode, the setting height of the display 242 on the second supporting part 20 is a fourth display height between 150 cm and 190 cm. Within this height range, an angle between a line-of-sight from which most visitors watch the display 242 and the horizontal line is within a range of 30 degrees upward to 45 degrees downward, which can thus enable most visitors to obtain more comfortable viewing experience.

The wireless communication unit 244 is connected with the display 242, and the display 242 can exchange information with other external apparatuses through the wireless communication unit 244 to make it convenient to switch display content of the display 242. In this implementation mode, the wireless communication unit 244 is integrated inside the display 242. The wireless communication unit 244 achieves mutual communication between the display and the external apparatuses in a wireless manner such as a local area network, a wide area network, infrared rays, radio, Wi-Fi, a 2G network, a 3G network, a 4G network, a 5G network, a point to point (P2P) network, a telecom networks or a cloud network.

In a further implementation mode, the mobile terminal of the aerial vehicle may exchange information with the display 242. Specifically, the mobile terminal may exchange information with the display 242 in a wired or wireless manner (for example, through the wireless communication unit 244) to control turn-on/turn-off of the display 242, switching of the display content and the like.

In a further implementation mode, the remote controller of the aerial vehicle may control the display 242. For example, it may control turn-on/turn-off of the display 242, switching of the display content and the like through the wireless communication unit 244.

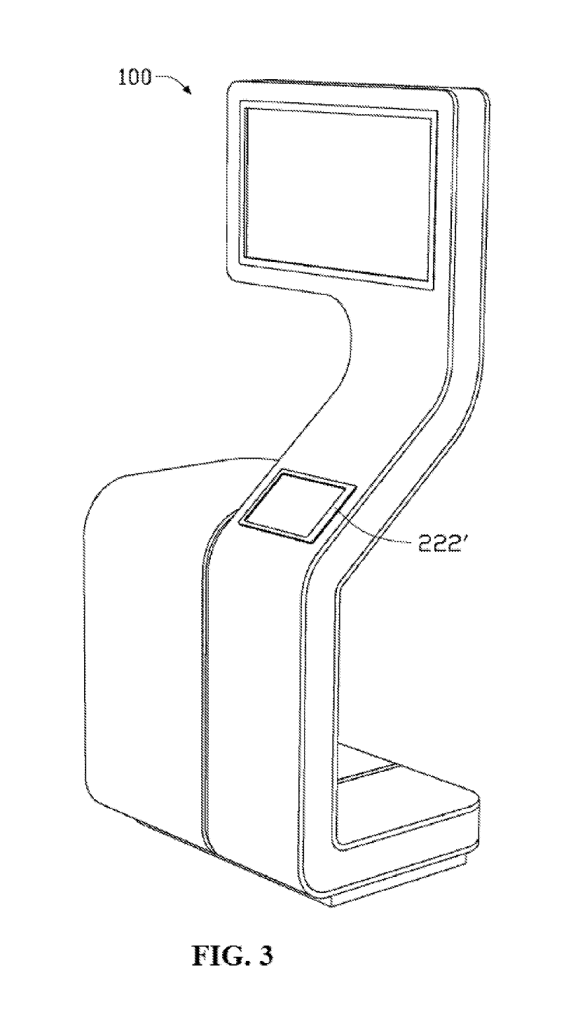

Referring to FIG. 3, an article display stand 200 according to another implementation mode of the present disclosure has a structure similar to the article display stand 100 in the implementation mode of FIG. 1. In addition, a first positioning structure 222′ of the article display stand 200 is a frame structure, and the first positioning structure 222′ encloses a mobile terminal therein. In this implementation mode, the first positioning structure 222′ is made of a rubber material, for preventing the mobile terminal from being damaged due to vibration.

The article display stand uses different placement surfaces to set different parts of the article to be displayed, which can thus avoid disorder of the different parts of the displayed article, and achieve a better display effect. In addition, the first supporting part and the second supporting part of the article display stand can set different separable parts of the article to be displayed at different display heights, so that the separable parts can obtain most suitable display heights respectively, which can thus bring about better viewing and operating experience to visitors.

It can be understood that persons skilled in the art may also make other changes or the like used in the design of the present disclosure within the spirit of the present disclosure, as long as the changes do not depart from the technical effect of the present disclosure. The changes made according to the spirit of the present disclosure should all be included in the scope claimed in the present disclosure.

What is claimed is:

1. An article display stand comprising:
a first supporting part configured to support an aerial vehicle body of an aerial vehicle; and
a second supporting part configured to support a control terminal of the aerial vehicle.

2. The article display stand according to claim 1, wherein the first supporting part comprises a first placement portion which supports the aerial vehicle body at a first display height.

3. The article display stand according to claim 2, wherein the second supporting part comprises a second placement portion which supports the control terminal at a second display height.

4. The article display stand according to claim 3, wherein the control terminal comprises a mobile terminal configured to control an action of at least one of a shooting apparatus, a flight apparatus, or a stabilizing device on the aerial vehicle body.

5. The article display stand according to claim 3, wherein the control terminal comprises a mobile terminal configured to display and/or detect a state and related information of at least one of a shooting apparatus, a flight apparatus, or a stabilizing device on the aerial vehicle body.

6. The article display stand according to claim 3, wherein the control terminal comprises a remote controller configured to control an action of at least one of a shooting apparatus, a flight apparatus, or a stabilizing device on the aerial vehicle body.

7. The article display stand according to claim 3, wherein the second placement portion comprises a first positioning structure configured to support the control terminal at the second display height.

8. The article display stand according to claim 7, wherein:
the first positioning structure comprises:
a positioning portion configured to mate with the control terminal to dispose the control terminal on the second placement portion, and
a stop protruding portion configured to prevent the mobile terminal from tipping over and/or preventing the mobile terminal from sliding along the second placement portion; or
the first positioning structure includes a frame structure configured to enclose the control terminal.

9. The article display stand according to claim 7, wherein the second placement portion further comprises a second positioning structure which is higher than the first positioning structure.

10. The article display stand according to claim 9, wherein the control terminal is supported by the second positioning structure.

11. The article display stand according to claim 9, wherein the second positioning structure comprises:
a mounting block fixedly arranged on the second placement portion, and
a plurality of hooks fixedly arranged on the mounting block configured to hold the control terminal.

12. The article display stand according to claim 3, wherein the display stand further comprises an information display portion which is located on the second supporting part, the information display portion comprises a wireless communication unit connected with the display, and the display is configured to exchange information with an external apparatus through the wireless communication unit.

13. The article display stand according to claim 12, wherein the information display portion comprises a bracket and a display supported by the bracket, and the control terminal is further configured to control the display.

14. The article display stand according to claim 1, further comprising: a light-emitting portion.

15. The article display stand according to claim 14, wherein the light-emitting portion includes at least one light source which is located near to where the aerial vehicle body and the control terminal are supported.

16. The article display stand according to claim 1, wherein:
the first supporting part comprises a first leg at a bottom of the first supporting part, a first supporting plate at a top of the first supporting part, and a first connecting portion that connects the first leg with the first supporting plate,
the first placement portion includes a surface of the first supporting plate, and
the first leg is in a shape of any one of following symbols: [symbol] , C, Σ, and Π.

17. The article display stand according to claim 1, wherein:
the second supporting part comprises a second leg at a bottom of the second supporting part, a second supporting plate, and a second connecting portion that connects the second leg with the second supporting plate, and
a surface of the second supporting plate is configured to support the control terminal.

18. The article display stand according to claim 17, wherein the second supporting plate is inclined at a predetermined angle relative to a bottom face of the second leg.

19. An article display stand comprising:
a first supporting part comprising a first placement portion configured to support at least one of a plurality of separable parts of an article at a first display height; and
a second supporting part comprising a second placement portion configured to support at least another one of the separable parts at a second display height.

20. The article display stand according to claim 19, wherein the first display height is different from the second display height.
